(19) United States
(12) Patent Application Publication
(10) Pub. No.: US 2012/0293805 A1
(43) Pub. Date: Nov. 22, 2012

(54) INTERFERENCE MEASURING APPARATUS AND MEASURING METHOD THEREOF

(76) Inventors: Chien-Chung TSAI, Taipei (TW); Dong-Yo Jheng, Taipei (TW); Yu-Ta Wang, Taipei (TW); Yen-Sheng Lin, Taipei (TW); Kuang-Yu Hsu, Taipei (TW); Sheng-Lung Huang, Taipei (TW)

(21) Appl. No.: 13/543,505

(22) Filed: Jul. 6, 2012

Related U.S. Application Data
(62) Division of application No. 12/651,135, filed on Dec. 31, 2009.

(30) Foreign Application Priority Data
Aug. 11, 2009 (TW) 098126993

(51) Int. Cl. G01B 9/02; G01J 3/45

(52) U.S. Cl. 356/453; 356/491

(57) ABSTRACT

An interference measuring apparatus comprises a light source module, a beam splitter, a first lens module, a reflecting module, a second lens module, and a detection device. A light beam generated from the light source module can be projected on the beam splitter. The beam splitter splits the light beam to generate a first light beam and a second light beam. The first light beam passes through the first lens module and then projects onto the reflecting module, and the second light beam passes through the second lens module and projects onto an object. Furthermore, the first light beam and the second light beam are reflected by the reflecting module and the object, respectively, then both the first light beam and the second light beam are leaded to the detection device to form an interference pattern for obtaining the contours and internal cross-sectional image of the object.

### RELATED APPLICATIONS

This application is a Divisional patent application of co-pending application Ser. No. 12/651,135, filed on 31 Dec. 2009. The entire disclosure of the prior application Ser. No. 12/651,135, from which an oath or declaration is supplied, is considered a part of the disclosure of the accompanying Divisional application and is hereby incorporated by reference.

### BACKGROUND OF THE INVENTION

1. Technical Field

The present invention is related to an interference measuring apparatus, and regarding more particularly an interference measuring apparatus with low coherent light.

2. Description of the Prior Art

The interference measuring apparatus can obtain the contours and internal cross-sectional image of an object according to the interference pattern of a reference light beam and an object light beam. Moreover, the interference measuring apparatus, such as optical coherence tomography, can be applied to the scan of an electrical circuit, mask, and human tissues. Referring to FIG. 1, what is shown is a schematic diagram of the interference measuring apparatus according to the prior art. The interference measuring apparatus 10 comprises a coherent light source 11, a collimator 12, a beam splitter 13 (such as a spectroscope), a lens 14, a reflecting mirror 15, and a spectrometer 16. A coherent light beam I, generated by the coherent light source 11, can pass through the collimator 12 to form a parallel light.

The beam splitter 13 can split the coherent light beam I into a reference light beam Ir and an object light beam Io, wherein the reference light beam Ir projects onto the reflecting mirror 15, and the object light beam Io passing through the lens 14 then be focused on an object 17. Afterwards, the reference light beam Ir reflected by the reflecting mirror 15 can pass through the beam splitter 13 to project on the spectrometer 16. The object light beam Io reflected and/or scattered by the object 17 can then be reflected by the beam splitter 13 to project onto the spectrometer 16. The reference light beam Io and the object light beam Ir that project onto the spectrometer 16 can form an interference pattern due to the optical path difference thereof. Therefore, the interference pattern obtained from the spectrometer 16 can be further analyzed to get the contours and internal cross-sectional image of the object 17.

A moveable platform 18 of the interference measuring apparatus 10 can carry the object 17 to move in the first direction X and the second direction Y. In this way, the object light beam Io that projects onto the object 17 can initiate a two-dimensional scan to get the contours and internal cross-sectional image of the object 17.

It is inconvenient to place the object 17 on the moveable platform 18 during the measuring process, especially when the size of the object 17 is larger than the platform 18. Moreover, while the light source of the interference measuring apparatus 10 is a low coherent light source, dispersion may occur, and the optical path between the reference light beam Ir and the object light beam Io may be different, causing an error in measurement. Therefore, the light source of the conventional interference measuring apparatus 10 is limited to a coherent light source 11.

### SUMMARY OF THE INVENTION

It is a primary objective of the present invention to provide an interference measuring apparatus, wherein there are a first lens module and a second lens module located on the first and second light paths of the first light beam and the second light beam, respectively, and the first and second light paths are very similar.

It is a secondary objective of the present invention to provide an interference measuring apparatus, wherein the first light beam and the second light beam pass through similar lens modules and have similar optical paths in order to avoid dispersion.

It is another objective of the present invention to provide an interference measuring apparatus, wherein a low coherent light can be used to initiate measuring, and the resolution of the scan can be improved.

It is still another objective of the present invention to provide an interference measuring apparatus, wherein the optical delay device comprises a rotary table and a plurality of reflecting units, where the angle of each reflecting unit can be adjusted individually to improve measurement accuracy.

It is still another objective of the present invention to provide an interference measuring apparatus, wherein the scanning mirror comprises a motorized goniometer and a galvo mirror, and the light beam can project onto a fixed position of the scanning mirror to avoid measurement errors.

It is still another objective of the present invention to provide an interference measuring apparatus, wherein the scanning mirror can initiate a two-dimensional scan of the object to obtain the contours and internal cross-sectional image of the object.

According to the above objectives, an interference measuring apparatus comprises: a light source module for generating a light beam; a beam splitter for splitting the light beam into a first light beam and a second light beam; a first lens module; a reflecting module, wherein the first light beam passes through the first lens module and projects onto the reflecting module; a second lens module, wherein the second light beam passes through the second lens module and projects onto an object; and a detection device for receiving the first light beam reflected by the reflecting module and the second light beam reflected and/or scattered by the object.

According to the above objectives, presented is a measuring method of an interference measuring apparatus, wherein the interference measuring apparatus comprises a light source module, a beam splitter, a first lens module, a second lens module, a reflecting module, and a detection device, and the measuring method comprises the steps of: generating a light beam from the light source module; projecting the light beam onto the beam splitter; splitting the light beam by the beam splitter to form a first light beam and a second light beam; leading the first light beam to pass through the first lens module and projecting said first light beam onto the reflecting module; reflecting the first light beam, via the reflecting module, to pass through the first lens module and the beam splitter, and projecting said first light beam onto the detection device, wherein a first optical path is defined as the distance of the first light beam passing through the first lens module from the beam splitter to the reflecting module, plus the distance of the first light beam passing through the first lens module and the beam splitter from the reflecting module to the detection device; leading the second light beam to pass through the second lens module and projecting the second light beam onto an object; and reflecting and/or scattering the second light beam by the object to pass through the second lens module, wherein the second light beam is reflected by the beam splitter to project onto the detection device, wherein a second optical path is defined as the distance of the second light beam passing through the second lens module from the beam splitter to the object, plus the distance of the second light beam passing through the second lens module from the object to the detection device, wherein the first optical path is similar to the second optical path.

### BRIEF DESCRIPTION OF THE DRAWINGS

FIG. 1 is a schematic diagram of the interference measuring apparatus according to the prior art;

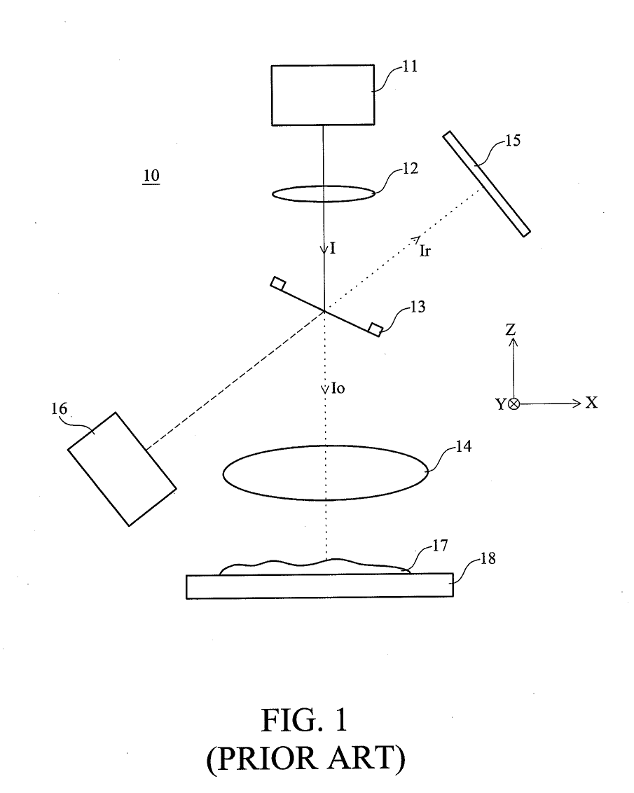

FIG. 2 is a schematic diagram of an interference measuring apparatus according to an embodiment of the present invention;

FIG. 3A is a side view of the optical delay device of the interference measuring apparatus according to an embodiment of the present invention;

FIG. 3B is a top view of the optical delay device of the interference measuring apparatus according to an embodiment of the present invention;

FIG. 4 is a schematic diagram of the scanning mirror of the interference measuring apparatus according to an embodiment of the present invention;

FIG. 5 is schematic diagram of the interference measuring apparatus according to another embodiment of the present invention;

FIG. 6 is a schematic diagram of the interference measuring apparatus according to still another embodiment of the present invention;

FIG. 7 is a schematic diagram of the interference measuring apparatus according to another embodiment of the present invention;

FIG. 8 is schematic diagram of the interference measuring apparatus according to another embodiment of the present invention; and

FIG. 9 is schematic diagram of the interference measuring apparatus according to another embodiment of the present invention.

### DETAILED DESCRIPTION OF THE PREFERRED EMBODIMENTS

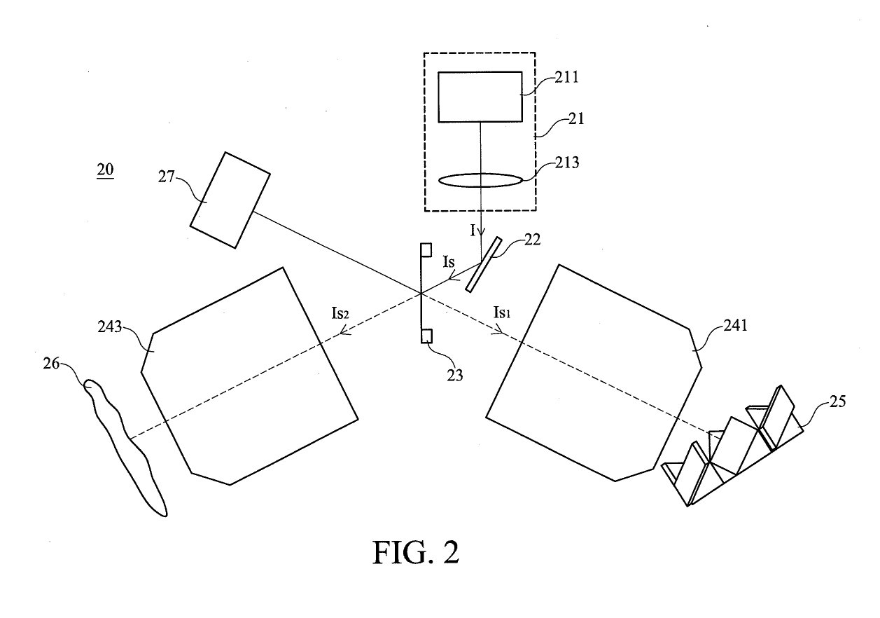

Referring to FIG. 2, a schematic diagram of an interference measuring apparatus according to an embodiment of the present invention is disclosed. The interference measuring apparatus 20 comprises a light source module 21, a scanning mirror 22, a beam splitter 23, a first lens module 241, a second lens module 243, an optical delay device 25, and a photodiode 27.

A light beam I generated by the light source module 21 can be a parallel light. In an embodiment of the invention, the light source module 21 comprises a light source generator 211 and a collimator 213, wherein a non-parallel light generated by the light source module 211 can pass through the collimator 213 to form the light beam I. For example, the light source generator 211 can be a light emitting diode or a broadband light source used to generate a diverging light source, and the collimator can be a lens or a lens module used to calibrate the diverging light source and generate the light beam I. Furthermore, the light beam I generated by the light source module 21 can be a coherent light or a low coherent light.

The light beam I generated by the light source module 21 can project onto the scanning mirror 22. For example, the scanning mirror 22 can change the angle of the light beam I for the purpose of guiding it to the beam splitter 23. As another example, the scanning mirror 22 can rotate in a horizontal and/or vertical direction. The light beam I reflected by the scanning mirror 22 can be a scanning light beam Is used to scan a region, with one or two dimensional scan.

The beam splitter 23 can split the scanning light beam Is, wherein one part of the scanning light beam Is can be reflected by the beam splitter 23, and the other scanning light beam Is can pass through the beam splitter 23. The light beam reflected by the beam splitter 23 can be defined as a first light beam Is1, and the light beam that passes through the beam splitter 23 can be defined as a second light beam Is2.

The first lens module 241 and the second lens module 243 can be located on opposite sides of the beam splitter 23. For example, the first light beam Is1 can pass through the first lens module 241 located on one side of the beam splitter 23, and the second light beam Is2 can pass through the second lens module 243 located on the other side of the beam splitter 23. Moreover, the first lens module 241 and the second lens module 243 can be with substantially the same structure.

The first light beam Is1 that passes through the first lens module 241 can be projected onto the optical delay device 25 located behind the first lens module 241, and the second light beam Is2 that passes through the second lens module 243 can be projected onto the object 26 located behind the second lens module 243. The second lens module 243 focuses the second light beam Is2 on the surface of the object 26, and the first lens module 241 focuses the first light beam Is1 on the optical delay device 25.

The second light beam Is2 is reflected and/or scattered by the object 26 and passes through the second lens module 243 again to project onto the photodiode 27, and the first light beam Is1 is reflected by the optical delay device 25 and passes through the first lens module 241 and the beam splitter 23 in turn to project onto the photodiode 27.

In one embodiment of the invention, the first light beam Is1 can be a reference light beam, and the second light beam Is2 can be an object light beam. The first light beam Is1 and the second light beam Is2 that project onto the photodiode 27 can form an interference pattern for obtaining the contours and internal cross-sectional image of the object 26.

In addition, the first lens module 241 and the second lens module 243 can be with substantially the same structure, wherein the first lens module 241 can be an optical compensation lens module. Thereby, the optical path and the dispersion based on the first light beam Is1 passing through the first lens module 241 is very similar to that based on the second light beam Is2 passing through the second lens module 243. Moreover, the light beam I generated by the light source module 21 of the interference measuring apparatus 20 can be a coherent light or a low coherent light.

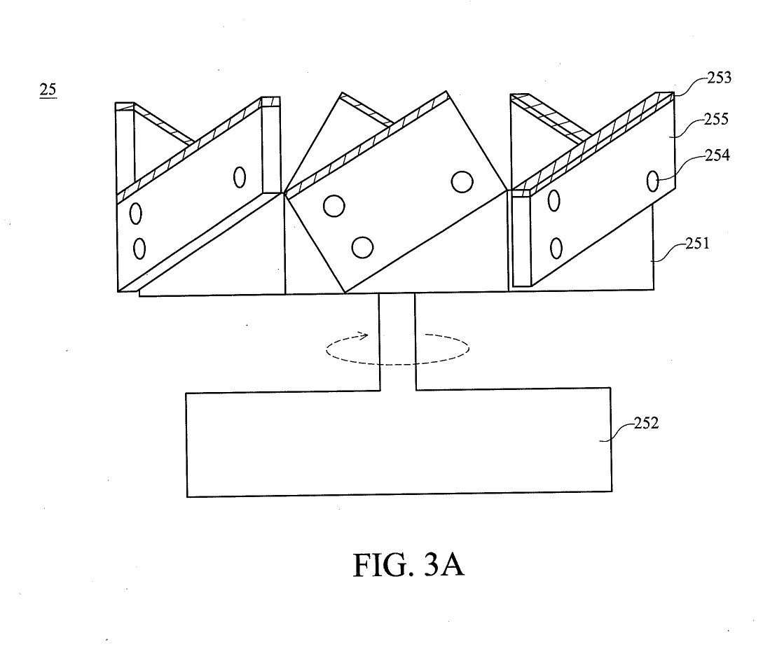

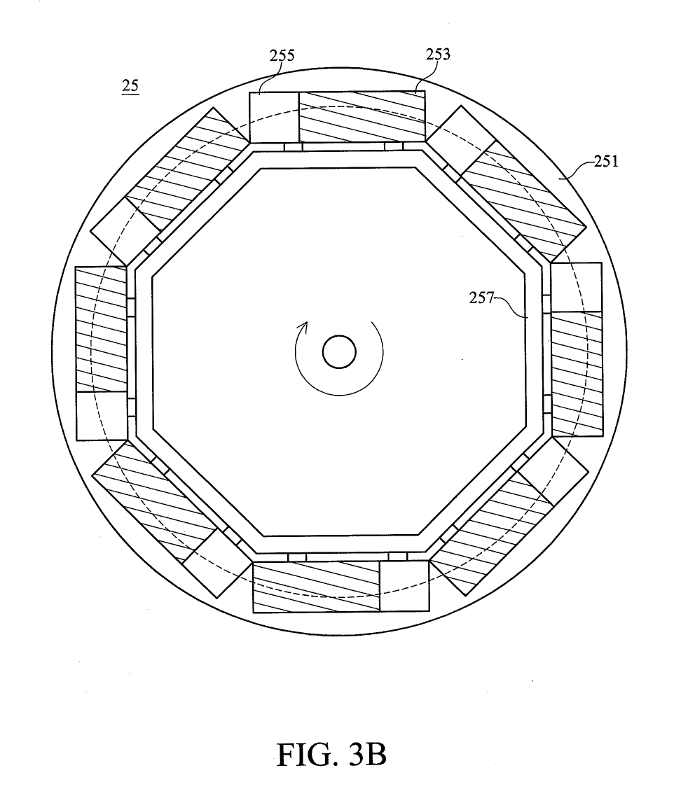

Referring to FIG. 3A and FIG. 3B, a side view and top view of the optical delay device of the interference measuring apparatus according to an embodiment of the present invention are disclosed, respectively. The optical delay device 25 comprises a rotary table 251 and a plurality of reflecting units 253 located on the rotary table 251. A rotating motor 252 can connect to the rotary table 251, and drive the rotary table 251 to rotate.

In one embodiment of the invention, the rotary table 251 comprises at least one fixing element 257, and a reflecting unit 253 connected to the fixing element 257 via a bearer 255. Furthermore, the bearer 255 can be fixed on the fixing element 257 via a plurality of connection units 254, and the reflecting angle of each reflecting unit 253 can be changed individually by adjusting the position between the bearer 255 and the fixing element 257. For example, the connection unit 254 can be an adjustable screw.

The optical delay device 25 can comprise eight reflecting units 253 and bearers 255, with each reflecting unit 253 connected to the fixing element 257 of the rotary table 251 via the bearer 255, as shown in FIG. 3B. Thereafter, the angle and the position of eight reflecting units 253 and bearers 255 can be individually changed.

The reflecting units 253 and the bearers 255 can be located on the top surface of the rotary table 251 at a tilt, and the first light beam Is1 can project onto the dashed line, as shown in FIG. 3B. While the first light beam Is1 projects onto the optical delay device 25, the first light beam Is1 that projects onto the reflecting unit 253 can be reflected, and the first light beam Is1 that projects onto the bearer 255 cannot be reflected.

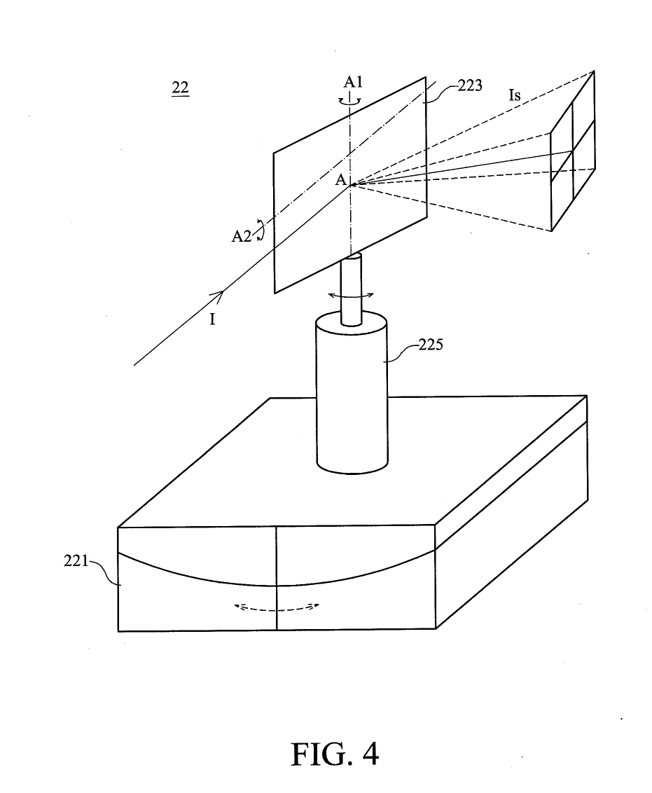

Referring to FIG. 4, a schematic diagram of the scanning mirror of the interference measuring apparatus according to an embodiment of the present invention is disclosed. The scanning mirror 22 comprises a motorized goniometer 221 and a galvo mirror 223. The angle of the light beam reflected by the scanning mirror 22 can be variable to form a two-dimensional scanning light beam Is that initiates the two-dimensional scanning of the object 26.

In one embodiment of the invention, the galvo mirror 223 is connected to a rotating motor 225, such that the galvo mirror 223 can rotate around a first axis A1. For example, the first axis A1 can be a vertical line. In addition, the rotating motor 225 can combine with the motorized goniometer 221, and the galvo mirror 223 is able to rotate around the second axis A2, by adjusting the position and the height of the galve mirror 223 on the motorized goniometer 221. For example, the second axis A2 can be a horizontal line. Furthermore, the second axis A2 and the light beam I can be parallel or coaxial. For example, the second axis A2 and the surface of the mirror do not overlap each other.

The light beam I can project onto a fixed position A of the galvo mirror 223 by adjusting the position between the light beam I and the galvo mirror 223. For example, while the galvo mirror 223 rotates around the first axis A1 and/or the second axis A2, the light beam I can project onto a fixed position A of the galvo mirror 223 to improve measurement accuracy.

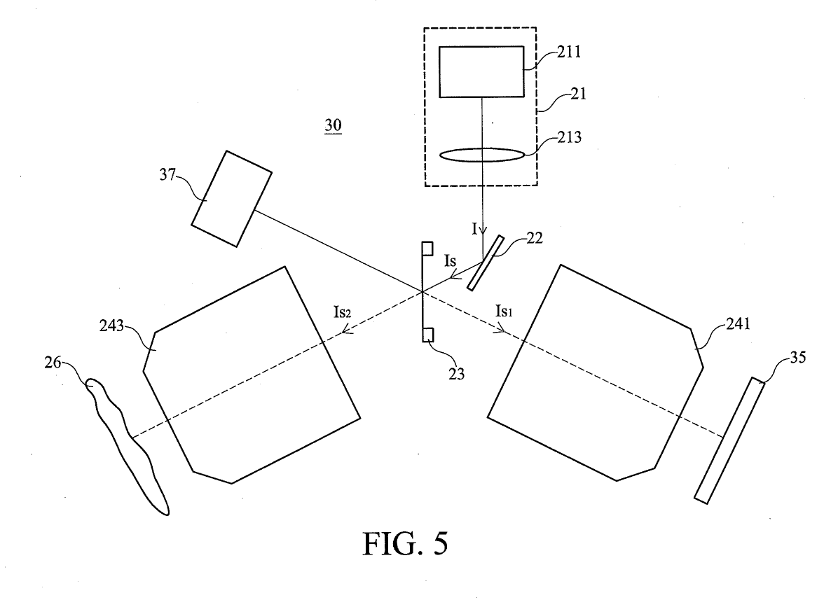

Referring to FIG. 5, a schematic diagram of the interference measuring apparatus according to another embodiment of the present invention is disclosed. The interference measuring apparatus 30 comprises a light source module 21, a scanning mirror 22, a beam splitter 23, a first lens module 241, a second lens module 243, a reflecting mirror 35, and a spectrometer 37.

In the embodiment of the invention, the scanning mirror 22 can reflect the parallel light beam I generated by the light source module 21 to form a scanning light beam Is, and the angle of the scanning light beam Is can change over time. The beam splitter 23 can split the scanning light beam Is into a first light beam Is1 and a second light beam Is2, wherein the first light beam Is1 can pass through the first lens module 241 to project onto the reflecting mirror 35, and the second light beam Is2 can pass through the second lens module 243 to project onto the object 26.

The first light beam Is1, reflected by the reflecting mirror 35, can pass through the first lens module 241 and the beam splitter 23 to project onto the spectrometer 37. The second light beam Is2, reflected and/or scattered by the object 26, can pass through the second lens module 243 to be reflected by the beam splitter 23 and be projected onto the spectrometer 37. The spectrometer 37 can analyze or calculate the interference pattern of the first light beam Is1 and the second light beam Is2 to obtain the contours and internal cross-sectional image of the object 26.

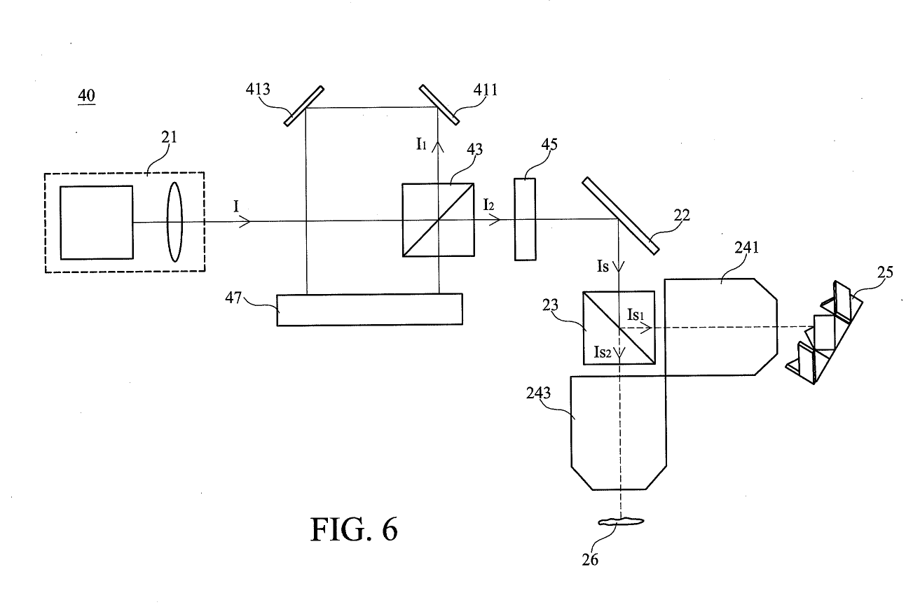

Referring to FIG. 6, a schematic diagram of the interference measuring apparatus according to another embodiment of the present invention is disclosed. In practical use, the interference measuring apparatus 20/30 of the FIG. 2 and FIG. 5 can be applied to various devices by adjusting the position of the components thereof. As shown in FIG. 6, the polarization beam splitter 43 can split the light beam I generated by the light source module 21 into a first polarization light beam I1 and a second polarization light beam I2. The first polarization light beam I1 reflected by the polarization beam splitter 43 can be reflected by the first reflecting mirror 411 and the second reflecting mirror 413, in turn to project onto the balance detector 47.

The second polarization light beam I2 can pass through the polarization beam splitter 43 and the wave plate 45, such as a quarter wave plate, to project onto the scanning mirror 22. The angle of the second polarization light beam I2 reflected by the scanning mirror 22 can change over time to form a scanning light beam Is. The beam splitter 23 can split the scanning light beam Is, thus into a first light beam Is1 and a second light beam Is2. The first light beam Is1 that passes through the first lens module 241 can project onto the optical delay device 25, and the second light beam Is2 that passes through the second lens module 243 can project onto the object 26.

The first light beam Is1 reflected by the optical delay device 25 can pass through the first lens module 241 to be reflected by the beam splitter 23, the scanning mirror 22, and the polarization beam splitter 43, in turn, then project onto the balance detector 47. The second light beam Is2, reflected and/or scattered by the object 26, can pass through the second lens module 243 and the beam splitter 23 to be reflected by the scanning mirror 22 and the polarization beam splitter 43 in turn to project onto the balanced detector 47. Thereby, the balanced detector 47 can obtain the contours and internal cross-sectional image of the object 26. In a different embodiment of the invention, the optical delay device 25 can be replaced with a reflecting mirror 35, and the balanced detector 47 can be replaced with a spectrometer.

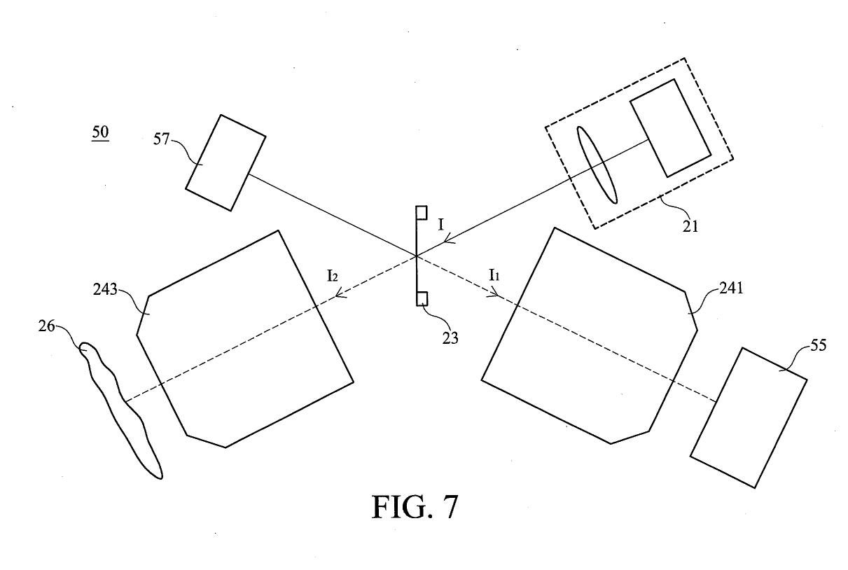

Referring to FIG. 7, a schematic diagram of the interference measuring apparatus according to another embodiment of the present invention is disclosed. The interference measuring apparatus 50 comprises a light source module 21, a beam splitter 23, a first lens module 241, a reflecting module 55, and a detection device 57. The light beam I generated by the light source module 21 can project onto the beam splitter 23, thus being split into a first light beam I1 and a second light beam I2.

The first light beam I1 that passes through the first lens module 241 can project onto the reflecting module 55. Thereafter, the first beam I1 reflected by the reflecting module 55 can pass through the first lens module 241 and the beam splitter 23 to project onto the detection device 57. Moreover, a first optical path is defined as the distance of the first light beam I1 passing through the first lens module 241 from the beam splitter 23 to the reflecting module 55, plus the distance of the first light beam I1 passing through the first lens module 241 and the beam splitter 23 from the reflecting module 55 to the detection device 57.

The second light beam I2 that passes through the second lens module 243 can project onto the object 26. Thereafter, the second light beam I2, scattered and/or reflected by the object 26, can pass through the second lens module 243, and then the beam splitter 23 can reflect the second light beam I2 to project onto the detection device 57. A second optical path is defined as the distance of the second light beam I2 passing through the second lens module 243 from the beam splitter to the object 26, plus the distance of the second light beam I2 passing through the second lens module 243 from the object 26 to the detection device 57. The above-mentioned first optical path is similar to the second optical path.

The reflecting module 55 can be the optical delay device (25) or the reflecting mirror (35), and the detection device 57 can be the spectrometer (37), the photodiode (27), or the balanced detector (47). For example, as the reflecting module 55 is the optical delay device (25), the detection device 57 can be a photodiode (27), as shown in FIG. 2. As the reflecting module 55 is the reflecting mirror (35), the detection device 57 can be a spectrometer (37), as shown in FIG. 5.

In another embodiment of the invention, the interference measuring apparatus 50 can comprise a scanning mirror (22), and the light beam I generated by the light source module 21 can project onto the scanning mirror (22). The light beam I reflected by the scanning mirror (22) can form a scanning light beam Is to project onto the beam splitter 23 and split the scanning light beam Is. In one embodiment of the invention, if the interference measuring apparatus 50 that has a scanning mirror (22) can initiate a two-dimensional scanning of the fixed object 26. If the interference measuring apparatus 50 without the scanning mirror (22), the object 26 can be dispose upon a moveable platform to adjust the two-dimensional position thereon.

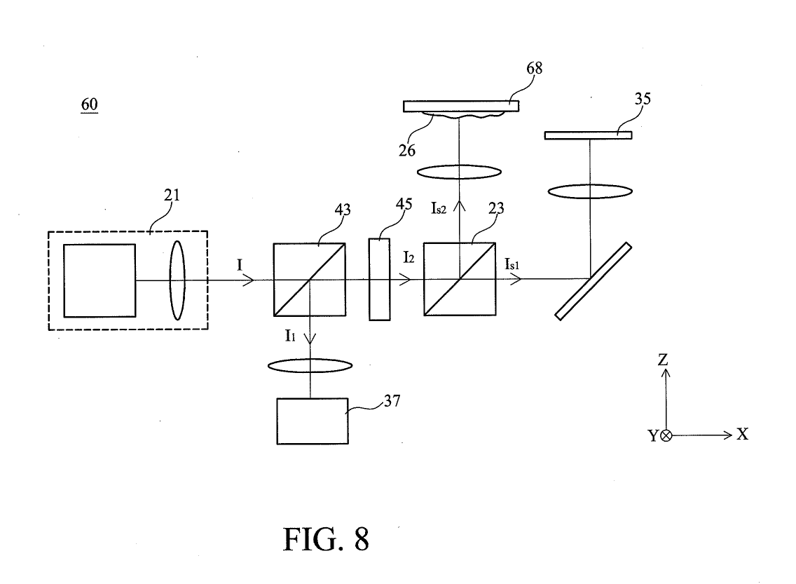

Referring to FIG. 8, a schematic diagram of an interference measuring apparatus according to an embodiment of the present invention is disclosed. The interference measuring apparatus 60 comprises a light source module 21, a polarization beam splitter 43, a wave plate 45, a beam splitter 23, a reflecting mirror 35, and a spectrometer 37.

The light beam I generated by the light source module 21 can project onto the polarization beam splitter 43 for splitting the light beam I to generate a first polarization light beam I1 and a second polarization light beam I2. The first polarization light beam I1 can project on the spectrometer 37, and the second polarization light beam I2 can pass through the wave plate 45, such as a quarter wave plate.

The beam splitter 23 can split the second polarization light beam I2, wherein one part of the second polarization light beam I2 can be reflected by the beam splitter 23, and the other second polarization light beam I2 can pass through the beam splitter 23. The light beam reflected by the beam splitter 23 can be defined as a sample light beam Is2, and the light beam that passes through the beam splitter 23 can be defined as a reference light beam Is1.

The reference light beam Is1 that passes through the beam splitter 23 can be projected onto the reflecting mirror 35, and the sample light beam Is2 reflected by the beam splitter 23 can be projected onto the object 26 deposited on a moveable platform 68. The moveable platform 68 can carry the object 26 to move in the first direction X and the second direction Y. In this way, the sample light beam Is2 that projects onto the object 26 can initiate a two-dimensional scan to get the contours and internal cross-sectional image of the object 26.

The sample light beam Is2 is reflected and/or scattered by the object 26 and reflected by the beam splitter 23 again to project onto the spectrometer 37. For example, the sample light beam Is2 reflected and/or scattered by the beam splitter 23 can pass through the wave plate 45, and be reflected by the polarization beam splitter 43 to project onto the spectrometer 37. The reference light beam Is1 reflected by the reflecting mirror 35 can passes through the beam splitter 23 and the wave plate 45 in turn, and be reflected by the polarization beam splitter 43 to project onto the spectrometer 37.

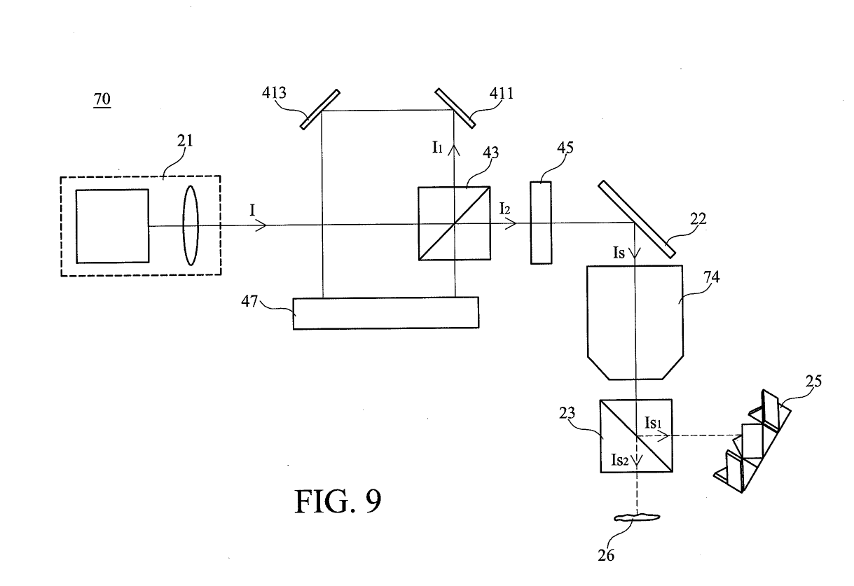

Referring to FIG. 9, a schematic diagram of an interference measuring apparatus according to an embodiment of the present invention is disclosed. The interference measuring apparatus 70 comprises a light source module 21, a polarization beam splitter 43, a wave plate 45, a scanning mirror 22, a lens module 74, a beam splitter 23, an optical delay device 25, and a balance detector 47.

The light beam I generated by the light source module 21 can project onto the polarization beam splitter 43 for splitting the light beam I to generate a first polarization light beam I1 and a second polarization light beam I2. The first polarization light beam I1 can project on balance detector 47, such as the first polarization light beam I1 can be reflected by the first reflecting mirror 411 and the second reflecting mirror 413, in turn to project onto the balance detector 47. The second polarization light beam I2 can pass through the wave plate 45, such as a quarter wave plate.

The second polarization light beam I2 can be projected on the scanning mirror 22, and the scanning mirror 22 can reflect the second polarization light beam Is to form a scanning light beam Is, and the angle of the scanning light beam Is can change over time.

The scanning light beam Is can pass through the lens module 74, and project on the beam splitter 23. The beam splitter 23 can split the scanning light beam Is into a reference light beam Is1 and a sample light beam Is2, wherein the reference light beam Is1 can project onto the optical delay device 25, and the sample light beam Is2 can project onto the object 26.

The beam splitter 23, the lens module 74, the scanning mirror 22, the wave plate 45, and the polarization beam splitter 43 can guide the reference light beam Is1 reflected by the optical delay device 25 and the sample light beam Is2 reflected and/or scattered by the object 26 to project onto the balance detector 47.

The above embodiments are used only to illustrate the present invention, and are not intended to limit the scope thereof. Many modifications of the above embodiments can be made without departing from the spirit of the present invention.

What is claimed is:

1. An interference measuring apparatus comprising:
a light source module for generating a light beam;
a polarization beam splitter for splitting said light beam to generate a first polarization light beam and a second polarization light beam;
a wave plate for receiving said second polarization light beam, wherein said second polarization light beam passes through said wave plate;
a beam splitter for splitting said second polarization light beam to generate a reference light beam and a sample light beam, wherein said sample light beam is projected onto an object;
a reflecting module, wherein said reference light beam projects onto said reflecting module; and
a detection device for receiving said first polarization light beam generated by said polarization beam splitter, said reference light beam reflected by the reflecting module, and said sample light beam reflected and/or scattered by said object.

2. The interference measuring apparatus of claim 1, further comprising a lens module, wherein said sample light beam passes through said lens module and projects onto said beam splitter.

3. The interference measuring apparatus of claim 2, further comprising a scanning mirror which receives said sample light beam from said polarization beam splitter to generate a scanning light beam that passes through said lens module and projects onto said beam splitter.

4. The interference measuring apparatus of claim 3, wherein said scanning mirror comprises a motorized goniometer and a galvo mirror.

5. The interference measuring apparatus of claim 1, further comprising a moveable platform, wherein said object is deposited on said moveable platform.

6. The interference measuring apparatus of claim 1, wherein said wave plate is a quarter wave plate.

7. The interference measuring apparatus of claim 1, wherein said detection device is a spectrometer or a balanced detector.

8. The interference measuring apparatus of claim 1, wherein said reflecting module is an optical delay device or a reflecting mirror.

9. The interference measuring apparatus of claim 1, wherein said light beam generated by said light source module is a coherent light or a low coherent light.
